(19) United States
(12) Patent Application Publication
(10) Pub. No.: US 2018/0292982 A1
(43) Pub. Date: Oct. 11, 2018

(54) SYSTEM AND METHOD FOR CONFIGURING GRAPHICAL USER INTERFACE COMPONENTS FOR A MEDIA RICH COLLABORATIVE SPACE

(71) Applicant: William McCluskey, Tallahassee, FL (US)

(72) Inventor: William McCluskey, Tallahassee, FL (US)

(21) Appl. No.: 15/482,723

(22) Filed: Apr. 8, 2017

(51) Int. Cl. G06F 3/0484; G06F 3/0488; G06F 3/0486; G06F 17/30

(52) U.S. Cl. CPC G06F 3/04845; G06F 3/0488; G06T 11/206; G06F 17/30165; G06F 3/0486

(57) ABSTRACT

The present embodiment relates to an information creation and dissemination software tool for use with online external resources comprising of a flowchart graphic with user interface, which integrates rich media detail for use in a collaborative space. The collaborative space may be, personalized by a plurality of users and stored within the collaborative space domain. A plurality of users in the collaborative space may access or create informational and decisional elements, create and string text, access websites, and tag individual users within the collaborative space. Further sharing includes identifying information, video, audio, pictures or editing, following the contributions of multiple users in the collaborative space by using search methods such as text or tags.

### CROSS-REFERENCE TO RELATED APPLICATION

n/a

### STATEMENT REGARDING FEDERALLY SPONSORED RESEARCH OR DEVELOPMENT

n/a

### FIELD

The present embodiment relates to a system and method for configuring graphic user interface components, and in particular, to an enterprise management and sharing system that allows a user to define and share relevant data and resources.

### BACKGROUND

There is an immense amount of information available to users in an enterprise or collaborative space (intranet, internet, databases, etc.). However, with the vast amount of information available at the click of a mouse it becomes more difficult for user to identify relevant and useful information.

There is typically a disconnect between the information base in many collaborative spaces which may be categorized by topic, chronology, or relevance. This disconnect makes it nearly impossible to connect the relevant information with the user in an efficient manner.

Knowledge sharing is a vital tool for a user or enterprise of users to achieve maximum productivity and efficiency. Many enterprise users whether in the corporate, government or academic settings find it difficult to access information or find “best methods” required to perform tasks. As the corporate and academic settings continue to evolve, the complexity and scope of many of these tasks required often necessitate the use of sequence or combinations. Regardless of the frequency of these complex tasks, a user in an enterprise or collaborative space may need a plethora of tools to execute different applications and retrieve relevant information from a variety of sources.

One system and method of interface between enterprise management systems is through collaborative space interaction overlaid onto graphic user interfaces such as flowcharts and mobile views step-by step instructional design wizards. A “collaborative space” is further defined as a collaborative computing environment which incorporates user interface that combines different collaborative tools and functions to achieve a common goal. A workplace is a form of collaborative space that defines information dissemination, services, and applications to be incorporated into a working environment. These collaborative spaces if efficiently managed and executed enable a user or host of users to facilitate the performance of social or business activities. In this ever-changing environment, social and business environments are constantly customized to meet requirements for specific organizational needs and there is not a single system that allows users to harness the individual and synergistic contributions in one collective “space.”

The present embodiment addresses the about mentioned deficiencies found in the current prior art by providing a system and method for configuring graphical user interface components for an information sharing collaborative space. More specifically, the present embodiment provides a system and method graphically displaying meeting information which will enable a user to quickly collaborate and share texts, audio, websites, and other information elements and content to all other users in the collaborative space. Furthermore, the present embodiment allows for storing and editing user information and contributions for easy retrieval at a later time or save the information during the course of the presentation.

### SUMMARY OF THE INVENTION

The present embodiment provides a system and method for an enterprise management system that enables a user to define and share rich media data incorporated into flowcharts and instructional design wizards to create a cross platform for a defined collaborative space. Further the present embodiment describes a system and method relating to a collaborative space that utilizes rich media detail and visual overview with flowcharts that may be accessible through a host of mobile devices.

According to one aspect of the present embodiment, the method includes searching and classifying information utilizing tags, text, and users associated with the collaborative space according to its function, assigning the proper template/flowchart, and relating further collaborative information including text, video, audio, and pictures.

The flowchart graphic user interface includes a graphically first defined area as well as a display text box that limits character size to forty-five “word characters.” The flowchart graphic user interface enables a user to contribute a text string, video, audio, or picture within the first defined area. The flowchart graphic interface further includes a second defined area with at least one of the text strings, videos, audios or pictures being user selectable. The flowchart graphic user interface further includes relationship symbology displayable between the first and second defined areas. The software tool comprises a user selectable link corresponding to at least one of the text strings, videos, audios, or pictures. The selectable link is an active link or hyperlink that is configured for use with an online external resource. The symbology includes shapes and tags allowing users to create/edit shapes and tags and further connect different shapes within the flowchart. The flowchart may be saved with JSON and serialized, or immediately shared with other members of the collaborative space for further editing.

The current embodiment further enables “version control” of the flow chart or instructional design wizard for future use as a template for future collaborative sharing

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1A is a flowchart illustrating a user interface process and method for configuring a collaborative space for user-based information dissemination

FIG. 1B is a further flowchart illustrating a user interface process and method for configuring a collaborative space for user-based information dissemination.

### DETAILED DESCRIPTION

As used herein, relational terms, such as “first” and “second,” “top” and “bottom,” and the like, may be used solely to distinguish one entity or element from another entity or element without necessarily requiring or implying any physical or logical relationship or order between such entities or elements.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the following claims.

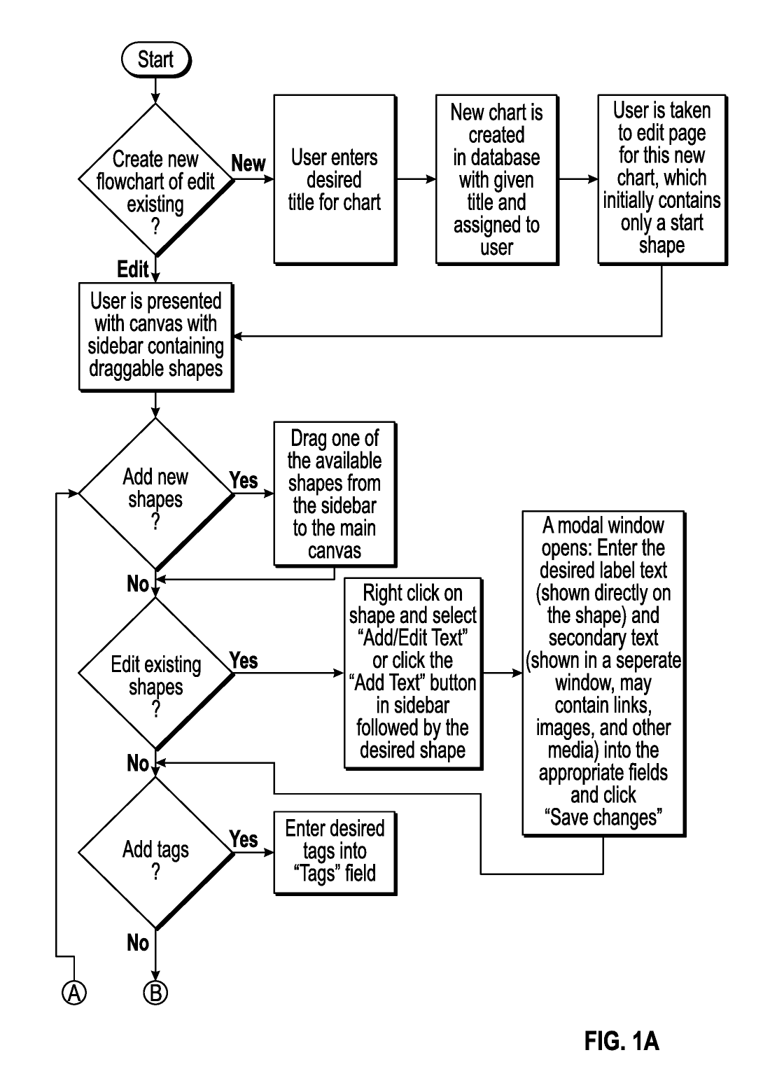

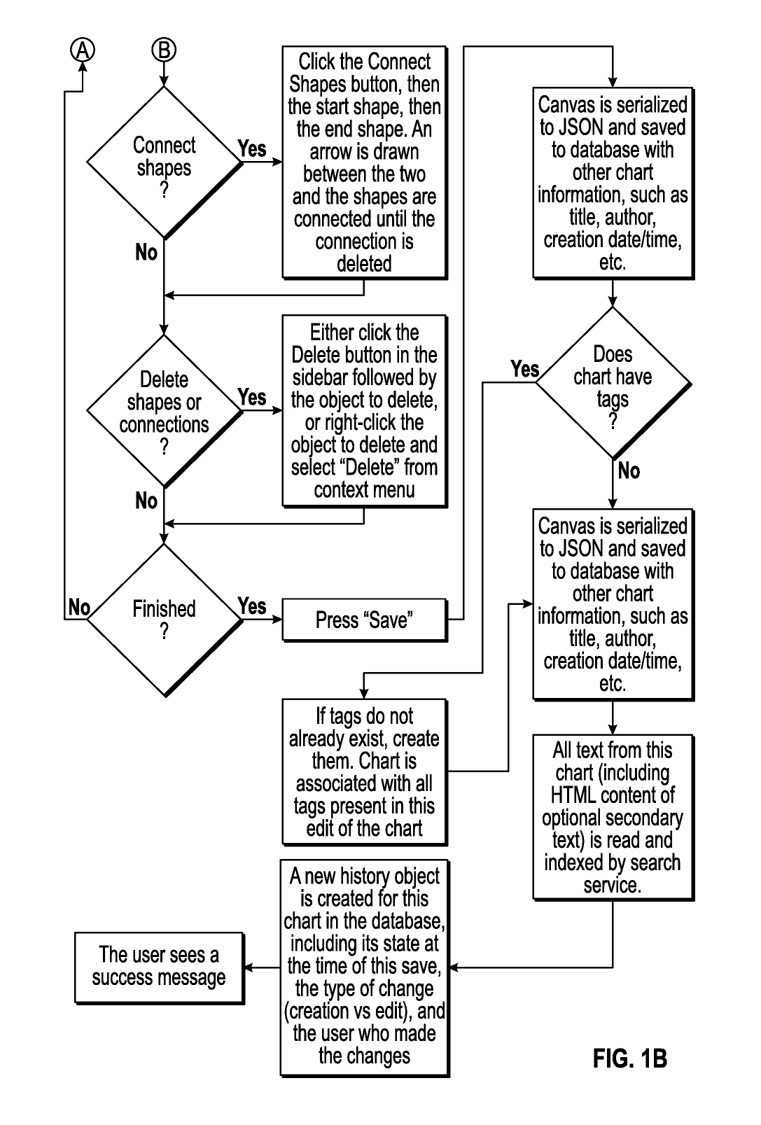

FIG. 1A shows a system and method 10 that may be used to classify type of collaborative spaces that correspond to defined information related to a collaborative entity or enterprise. The term “collaborative entity” may further be defined as users or groups of users in a space, organizations, corporations, or academic institutions.” The identification process 10 allows a contributor to generate a graphic user interface (i.e., flowchart) that allows users to search, publish, and share information using pre-defined flowcharts, existing shared flowcharts, or by text, tags, or different users.

In one application of the embodiment, system and method 10 is used in an academic institution shared network. For example, the collaborative space may be represented by media rich detail overlaid onto flowcharts. A customized user flowchart containing information about a specific collaborative topic is created by a user of the collaborative space, saved, and then shared with other members of the collaborative space using a host of search methods. Representing and sharing in the form of flowcharts and media rich detail links users in a consistent manner to every member of the collaborative space and may harness the individual knowledge of each member to create “best practices.”

The system and method 10 includes creating a graphic user interface for a specific purpose within the collaborative space 12. This graphic user interface creation may be contributed by individual users in the collaborative space, such as a person, department, agency, or institution (i.e., entities). The graphic user interface template is then deployed 14 and the flowchart may be customized to enable entities to customize rich media detail onto the flowcharts 18. Further, the flowcharts are deployed in the collaborative space using consistent terminology and symbology. The corresponding user may then publish their media rich detail information or save their information for future use in the collaborative space 20. In addition, the system and method 10 may provide standard navigation links to allow users to follow, access, or share information in the collaborative space searching existing links, tags, or text 22.

FIG. 2 provides an example of the current embodiment of the system and method 10 in which a user may create a new flowchart. The user initially has a choice to create or edit an existing flowchart 24. If the user elects to create a new flowchart 24, they first begin with method 10 by creating a title for flowchart 26. The user is then prompted to a new flowchart that is created, titled, and assigned to user 28, and the user is assigned only an initial start shape 30. Conversely, if the user elects to edit an existing flowchart 24, the user is provided canvassing on the sidebar with a host of draggable shapes 32. Further, the user has the option to elect new shapes to the flowchart 34. If the user elects to add new shape 34, the user may drag a new shape from the sidebar of the main canvas 36. The user also has the option of editing an existing shape 38 if he does not wish to create a new shape from the sidebar of the main canvas 36. The user may edit the shape 38 by right clicking and selecting “Add/Edit Text” from the drop-down menu. A modal window then opens and allows the user to enter the text and any secondary text into the appropriate field and save those changes 40. The system and method 10 also enables the user to add tags 42, and if elected, add the tags into the applicable field 44.

The system and method 10 may also enable a user to connect shapes 46, and if elected, the user may select the “connect shapes” which allows one to customize the arrow and connect the shapes of flowchart 48, based on the collaborative space topic. Conversely, the user may elect to delete any shape or connection 50 by clicking the delete button on the sidebar followed by the shape or connection to be deleted 50, or by right clicking the object to be deleted and selecting “delete” from context menu 52.

The system and method 10 then asks if the user is “finished” 54, and if so, the user will be prompted to press “save” 56. Once the user has pressed “save” 56, the flowchart is serialized in the JSON along with applicable fields such as title, author, creation date, and time 58. The system and method 10 then inquires if tags have been used on the flowchart 58. If not, the flowchart is serialized in the JSON along with applicable fields such as title, author, creation date, and time 58. Once the flowchart is created, all text and secondary content is saved and searchable 60. A new history input is created for the flowchart, including its state at the time of save, the type, and the editor of the change 62. Once the final edits have been made and the flowchart is saved in 62, a “success” message will be visible to the user 64.

What is claimed is:

1. A collaboration tool, comprising:
(a) a graphical user interface (GUI) configured to:
(i) enable creation of a flowchart by a plurality of users accessing the collaboration tool from different networked computers, each user enabled by the GUI to contribute information elements and content within an information element; and
(ii) enable viewing of the flowchart and/or step-by-step instructional design wizard including at least navigable buttons and touch navigation by a plurality of users; and
(iii) a database configured to store at least one flowchart and to store contributions to at least one flowchart from a plurality of users.

2. The collaboration tool of claim 1, wherein a user is enabled by the GUI to enter primary content which is displayed in a first view and to enter secondary content which is displayed in a second view.

3. The collaboration tool of claim 1, wherein the content of at least one information element is a link to one of different information element and a website.

4. The collaboration tool of claim 1, wherein an information element is one of a information box and a decisional element.

5. The collaboration tool of claim 4, wherein the database is searchable for content contributed by a specified user.

6. The collaboration tool of claim 1, wherein a contribution of a user is tagged by an identity of the user.

7. The collaboration tool of claim 1, wherein the content includes at least one of rich text, video, audio, and pictures.

8. The collaboration tool of claim 1, wherein a hierarchy of users is established so that some contributions may not be edited by some user.

9. The collaboration tool of claim 1, wherein the GUI further enables a user to link a first flowchart to a second flowchart.

10. A method of enabling collaboration between a plurality of user, the method including:
(a) enabling a plurality of users using networked computers to create a flowchart having information elements and content within each information element, each contributor contributing different information elements and different content; and
(b) storing and sharing the contributions in a searchable database and collaborative space.

11. The method of claim 10, wherein the information elements include information boxes to receive and display content specified by at least one user.

12. The method of claim 11, wherein an information box displays primary content and, when the information box is selected, secondary content is displayed.

13. The method of claim 10, wherein content of an information element contributed by a user may include a link to another information element.

14. The method of claim 10, wherein content of an element is associated with an identity of the user of the content.

15. The method of claim 14, wherein content is searchable based on an identity of the user of the searched-for content.

16. The method of claim 10, further comprising establishing a hierarchy of users and limiting editing rights based on a user's position within the hierarchy of the collaborative space.

17. A graphical user interface (GUI), configured to:
(a) display information elements including an information box and a decision element that can be dragged and dropped by a user onto a background canvas;
(b) add to the canvas an information element at the direction of at least one of a plurality of users accessing the GUI from different networked computers;
(c) add content to an information element at the direction of at least one of the plurality of users; and
(d) add connecting arrows between information elements at the direction of at least one of the plurality of users.

18. The GUI of claim 17, further configured to determine when a user is authorized to add an information element to the collaborative space.

19. The GUI of claim 17, further configured to determine when a user is authorized to add content to an information element.

20. The GUI of claim 17, further configured to display primary content in an information element and, when the information element is selected, to display secondary content.
